(19) United States
(12) Patent Application Publication
(10) Pub. No.: US 2007/0267204 A1
(43) Pub. Date: Nov. 22, 2007

(54) Soil raking and leveling device

(76) Inventor: Michael T. Grosberg, Chico, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/434,126

(22) Filed: May 16, 2006

(51) Int. Cl. A01B 15/00

(52) U.S. Cl. 172/383

(57) ABSTRACT

A soil raking and leveling device includes a rectangular frame having a rake secured to the front and a grading bar secured to the back. A side rail is attached to each side of the frame with each side rail having a bottom edge tapered forwardly and upwardly beginning from a point intermediate both ends of the side rail where a bottom edge of the scraper blade is positioned and tapered rearwardly and upwardly from the point to form a fulcrum about which the side rail pivots. A handle formed by a cross bar and a draw bar is pivotally attached to the front of the device and may be pivoted from a collapsed storage position to a first position extending outwardly and upwardly, a second position extending generally horizontally and a third position at a point lower than the second position and also extending horizontally outwardly. A pair of rear wheels are mounted adjacent the ends of the side rails.

### BACKGROUND OF THE INVENTION

1. Field of the Invention

The present invention relates to a soil raking and leveling device, and more particularly, the soil raking and leveling device adapted for either manual use or for attachment to a pulling vehicle and having a front rake and a rear leveling and grading bar mounted on a wheeled frame.

2. Description of the Related Art

Earth grading and leveling devices generally comprising a wheeled frame having a scraper blade thereon are well known and are either drawn by a vehicle or are self propelled and are used in large scale operations such as road or highway construction. There are also known many smaller earth leveling and grading device which include scarifying teeth in combination with a scraper blade which also are adapted to be pulled by a vehicle or may be self propelled and are used for smaller operation such as grooming drive ways and country roads and athletic fields constructed of earth. Examples of such smaller vehicle attached leveling and grading devices are shown in my copending U.S. application Ser. No. 11/149,260 and U.S. Pat. Nos. 4,217,962 and 4,898,247.

A need still exists however for a smaller soil raking and leveling device which may be pulled easily by hand or with a small pulling vehicle such as a riding mower and which evenly distributes soil, sand, gravel and other types of material without leaving ridges or gouges.

### SUMMARY OF THE INVENTION

It is an object of the present invention to provide a soil raking and leveling device which may be pulled manually by hand or may be attached to a small pulling vehicle and which has a wheeled frame mounting a front rake and a rear grading bar or blade.

A further object of the invention is to provide a soil raking and leveling device which may be collapsed for easy loading and storage.

Another object of the invention is to provide a soil raking and leveling device which is of simple construction and which may be used for smaller jobs such as raking and leveling yards, work areas and play areas and landscape grading and finishing.

Still another object of the invention is to provide a soil raking and leveling device having an adjustable and replaceable rake and grading bar.

The present invention achieves the above and other objects by providing a soil raking and leveling device which may be pulled manually by hand or by a small pulling vehicle wherein the device includes a frame having a front side, a back side and a pair of opposed sides. A rake is attached to the front side of the frame and a grading bar is attached to the back side of the frame. The device further includes side rails secured to each side of the frame with each side rail having a bottom edge tapered forwardly and upwardly beginning from a point intermediate both ends of the side rail where a bottom edge of the grading bar is positioned and tapered rearwardly and upwardly from the point to form a fulcrum about which the side rail pivots to cause the frame to pivot upwardly and downwardly. A pair of rear wheels are mounted adjacent the rear ends of the side rails. The device further includes a crossbar pivotally attached at each end to a first location on one of the side rails adjacent a front end thereof and a draw bar attached to the cross bar and extending forwardly therefrom. A pressure arm is attached to and extends outwardly from each end of the cross bar and a notch is provided in an upper edge towards the front of each of the side rails whereby when the pressure arms are seated in the notches, the cross bar and the draw arm are maintained in a first position for moving said device. Each of the side rails further includes a mounting hole at a second location which is an intermediate portion adjacent the front end thereof for pivotally attaching the cross bar to the side rails whereby when the cross bars are pivotally attached to the side rails using these mounting holes, the cross bar and the draw bar are maintained in a generally horizontal second position for moving the device. A retaining clip is mounted intermediate of the frame in horizontal alignment with the draw arm whereby when the cross bar and draw arm are pivoted to a stowed position extending back over the frame, the draw arm engages and is held in place by the retaining clip. The device further includes means for adjusting the rake and the grading bar vertically with respect to the frame.

These and other features and advantages of the present invention will become more apparent with reference to the following detailed description and drawings.

### BRIEF DESCRIPTION OF THE DRAWINGS

FIG. 1 is a perspective view of a soil raking and leveling device according to the present invention;

FIG. 2 is a side elevational view of a side rail of the present invention;

FIG. 3 is a top plan view of the cross bar and the draw arm of the present invention;

FIG. 4 is a side elevational view of the cross bar and the draw arm of FIG. 3;

FIG. 5 is a schematic side view of the present invention showing the cross arm and the draw bar in a folded storage position;

FIG. 6 is a schematic side view showing the cross arm and the draw bar in a first position angled upwardly;

FIG. 7 is a schematic side view showing the cross arm and the draw bar in a second position extending horizontally;

FIG. 8 is a schematic side view showing the cross arm and the draw bar in a third position extending horizontally at a lower level; and

FIG. 9 is an enlarged perspective view of a tow hitch of the present invention.

### DETAILED DESCRIPTION OF THE PREFERRED EMBODIMENTS

Illustrated in the drawings is a soil leveling and raking device 10 adapted to be either pulled manually by hand or towed by a small vehicle such as a garden tractor or a riding mower.

The soil raking and leveling device includes a rectangular frame 10 having a front 14, a back 16 and opposing sides 18 connected together in a generally rectangular shape.

A rake 22 is attached to the front 14 by any suitable means such as bolts and nuts whereby the rake may be removed when necessary. Moreover, the upper portion of the rake 22 preferably has elongated vertical slots through which the bolts extend so that the rake may be adjusted upwardly and downwardly with respect to the front to adjust the position of the teeth of the rake. The teeth of the rake penetrate the soil from 0 to 1 inch to scarify or rip the soil in order to loosen the top thereof for further grooming.

A grader bar 26 is attached to the back 16 of the frame by suitable means such as nuts and bolts. The grader bar 26 may be provided with elongated vertical slots through which the bolts extend so that the blade may be adjusted upwardly or downwardly with respect to the rear beam. The grader bar preferably is mounted at an angle of approximately 60° measured upwardly from a horizontal plane whereby a bottom edge of the grader bar is more forward than a top edge of the grader bar.

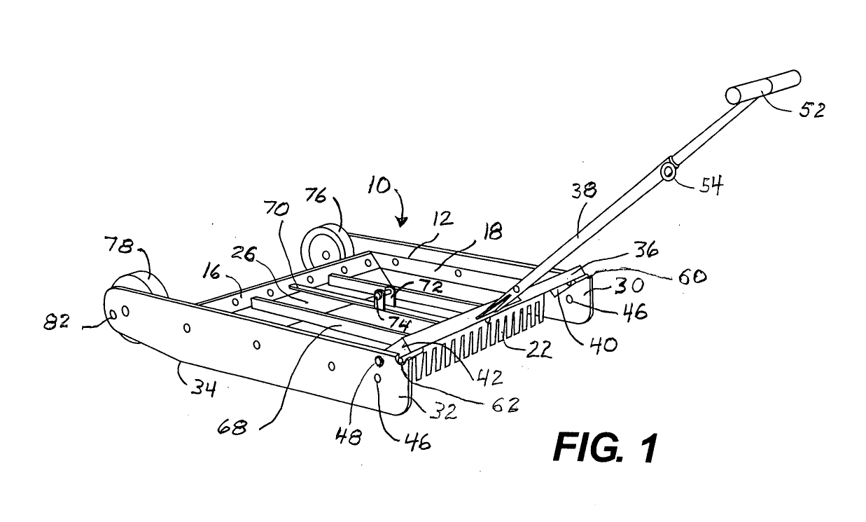

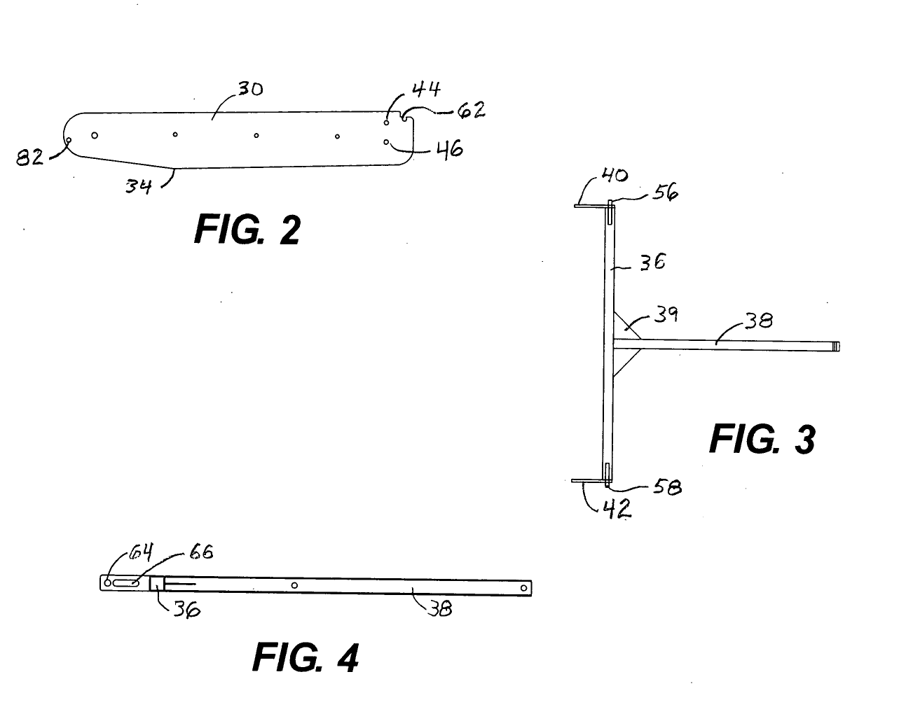

A first side rail 30 is secured to a side 18 on the right side of the device and a second opposed side 32 is secured to an opposite side 18 on the left side of the device. As shown in FIGS. 1 and 2, each of the side rails 30 and 32 has a fulcrum 34 located approximately ⅔ of the length of the side rail measured from the front of the rail and approximately ⅓ of the length measured from the rear of the rail. As shown in FIG. 6, the bottom edge of the grader bar 26 is positioned at the fulcrum 34 of each side rail. The fulcrum 34 serves as a pivot point about which the side rail pivots. Since the bottom edge of the grader bar 26 is at the exact fulcrum or pivot point of each side rail, the bottom of the blade stays at the same height as the side rails pivot up and down on a surface when the bottom of the blade is in contact with the surface.

A cross bar 36 having a first slide arm 40 at one end and a second slide arm 42 at the other end is pivotally attached adjacent the front end of the device by removable crevice pins or bolts 48 which extend through first upper mounting holes 44 in the side rails 30 and 32 and through walls in each of the slide arms 40 and 42. A draw bar 38 is attached to the front of the cross bar 36 in the center thereof by suitable means such as welding and gussets 39 and extends outwardly therefrom. At its outer end, the draw bar 38 is provided with a removable T-handle 52 which is telescopically received in the outer end of the draw bar and held in place by a removable detent pin 54. The T-handle 52 may be adjusted inwardly and outwardly from the end of the draw arm 38 to vary the combined length of the draw bar and the T-handle.

A first pressure arm 56 is attached to the left end of the cross bar 36 and extends outwardly therefrom and a second pressure arm 58 is attached to the right end of the cross bar 36 and extends outwardly therefrom as shown in FIG. 3. A first notch 60 is provided in the upper edge of the first side rail 30 adjacent the front thereof and a second notch 62 is provided on the top edge of the second side rail 32 adjacent the front end thereof. When the cross bar and the draw bar are in a first position angled upwardly as shown in FIG. 1, the first pressure arm 56 engages the first notch 60 and the second pressure arm 58 engages the second notch 62.

The slide arms 40 and 42 are each provided with a mounting hole 64 and an elongated slot 66 extending lengthwise of the slide arm as shown in FIG. 4.

The device is provided with support bars 68 extending lengthwise of the frame and are attached to the front 14 at one end and the back 16 at the other end as shown in FIG. 1. A flat support bar 70 is mounted to the front and back of the frame centrally thereof. A clip 72 having a removable pin 74 therein is mounted to the flat support bar 70 intermediate the ends thereof. The clip is constructed of a pair of spaced upwardly extending brackets having holes at the top thereof through which the removable pin 74 extends.

A left rear wheel 76 is attached adjacent a rear end of the first side rail 30 and a right rear wheel 78 is attached adjacent a rear end of the second side rail 32.

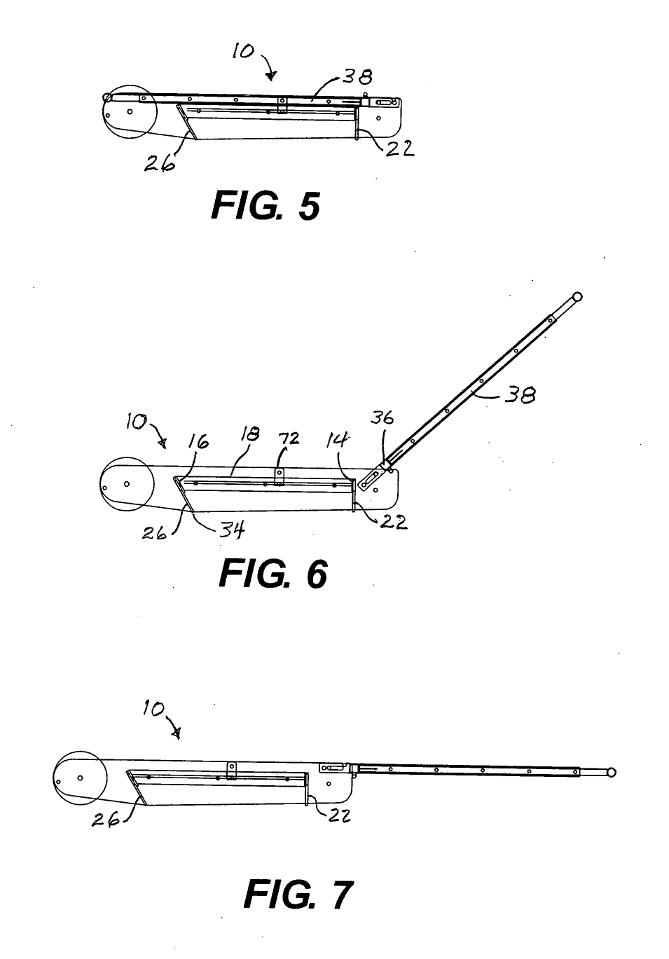

As shown in FIG. 5, the cross bar 36 and the draw bar 38 may be folded to a collapsed position lying flat across the frame 12 of the device for convenient packing or storage of the device. In the storage position, the draw bar 38 is held within the clip 72 by the pin 74.

When it is desired to operate the device, the pin 74 is removed from the clip 72 and the cross bar 36 and the draw bar 38 are rotated outwardly to a first set position wherein the draw bar 38 extends outwardly at an angle of approximately 45°. In this position, the pins 48 are at the front end of the slots 66 and the pressure arms 56 and 58 are held in the notches 60 and 62. When in this position, pressure may be put on the front rake by pushing down on the T-handle while dragging the device manually. Pushing down lightly with the fingers on the T-handle while dragging or pulling the device adds just enough pressure to grade soil evenly. Heavy pressure lifts the grading bar and engages the rake only since the side rails pivot downwardly about the fulcrum point 34 to lift the grading bar. The heavy pressure thus permits a more aggressive raking and scarifying action. Moreover, the adjustment slots provided in the rake permit a user to increase or decrease the scarifying depth. Similarly, the adjustment slots in the grading bar permit a user to increase or decrease the grading depth.

In the position shown in FIG. 7, the cross bar and the draw bar are horizontal, the pressure arms are moved out of the notches and are positioned adjacent the front of the side rails and the pin 48 in the upper mounting hole 44 engages the back end of the slot. Pulling or dragging the device when in this position is good for finish grading.

As shown in FIG. 9, a removable tow hitch 80 may be substituted in the end of the draw bar 38 for the T-handle 52. The tow hitch is particularly useful when it is desired to tow the device with a small pulling vehicle. The tow hitch 80 is also telescopically received within the end of the draw bar 38 to adjust the length thereof.

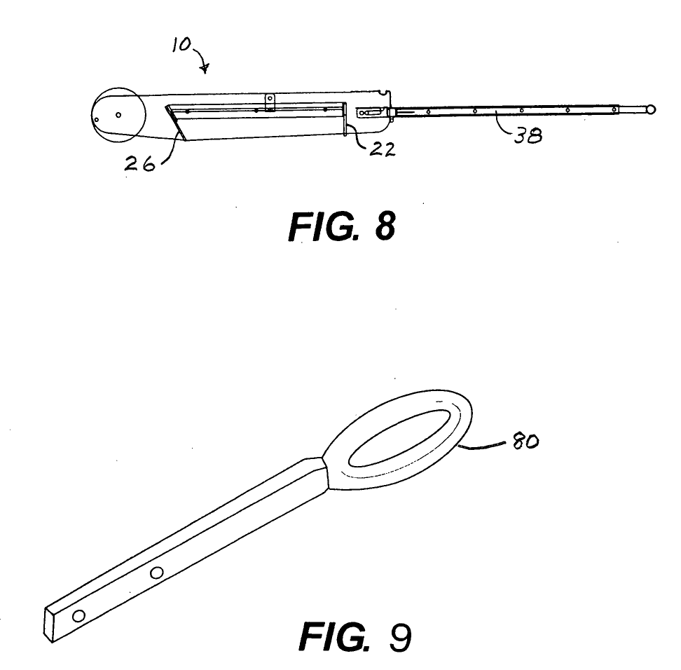

As shown in FIG. 8, the pins 48 may be removed from the first upper mounting holes 44 and the attachment point of the slide arms is moved lower to the second lower mounting holes 46 so that the draw arm extends horizontally outwardly from approximately the center of the side rails. This third position of the draw bar 34 is particularly useful when the device is being towed and a tow hitch is being used since the angle of the tow hitch is changed and the downward force is reduced.

As shown in FIGS. 1 and 2, an additional mounting hole is provided adjacent the back end of each side, rail which may be used for the attachment of auxiliary devices such as a roller for compacting and a drag for finishing the soil.

The soil raking and leveling device of the present invention has many advantages. The device is easy to drag or pull by hand and when a lot of hand raking needs to be done, the device gets the job done much faster than a conventional rake. The device is also an ergonomic tool since less bending is required and this reduces the wear and tear on a user's back and shoulders. If desired, of course, the device may be towed with a suitable pulling vehicle such as a ten horse power riding mower.

The soil raking and leveling device is preferably constructed with a double welded light weight steel frame, a replaceable steel rake, a replaceable grading bar, steel side rails, puncture proof wheels and also can be manually or vehicle towed. The device further permits a great savings in time in being used for activities such as landscape grading and finishing and grooming athletic fields, driveways, walk paths and the like.

Numerous other modifications and adaptations of the present invention will be apparent to those skilled in the art and thus, it is intended by the following claims, to cover all such modifications and adaptations which fall within the true spirit and scope of the invention.

I claim:

1. A soil raking and leveling device comprising:
a) a frame having a front, a back and a pair of opposed sides;
b) a rake secured to said front;
c) a grading bar secured to said back;
d) a side rail secured to each said side;
e) a cross bar pivotally attached at each end to a first location on one of said side rails adjacent a front end thereof;
f) a draw bar attached to said cross bar and extending forwardly therefrom;
g) a pressure arm attached to and extending outwardly from each end of said cross bar; and
h) a notch in an upper edge of each of said side rails adjacent the front end thereof for receiving a pressure arm whereby when said pressure arms are seated in said notches, said cross bar and said draw arm are maintained in a first position for moving said device.

2. A soil raking and leveling device according to claim 1 which further comprises a slide arm attached to each end of said cross bar, each said slide arm having an elongated slot extending lengthwise thereof; a pin extending through a first mounting hole at said first location in each of said side rails and through said slot in said slide arm whereby when said cross bar and said draw arm are maintained in said first position, said pin is at an outer end of said slot and when said cross bar and said draw arm are maintained in a second position, said pin is at an inner end of said slot.

3. A soil raking and leveling device according to claim 1, wherein each of said side rails further includes a second mounting hole at a second location which is an intermediate portion adjacent the front end thereof for pivotally attaching said cross bar to said side rails whereby when said cross bar is pivotally attached to said side rails using said second mounting holes, said cross bar and said draw bar are maintained in a third position for moving said device.

4. A soil raking and leveling device according to claim 1, which further comprises a wheel mounted adjacent a rear end of each of said side rails.

5. A soil raking and leveling device according to claim 1, wherein each said side rail has a bottom edge tapered forwardly and upwardly beginning from a point intermediate both ends of said side rail where a bottom edge of said grading bar is positioned and is tapered rearwardly and upwardly from said point to form a fulcrum about which said side rail pivots.

6. A soil raking and leveling device according to claim 1, which further comprises a retaining clip mounted intermediate of said frame in horizontal alignment with said draw arm whereby when said cross bar and said draw arm are moved to a stowed position extending back over said frame, said draw arm engages and is held in place by said retaining clip.

7. A soil raking and leveling device according to claim 1, which further comprises a wheel mounted adjacent a rear end of each of said side rails.

8. A soil raking and leveling device according to claim 1, which further comprises means for adjusting said rake vertically with respect to said front side of said frame and means for adjusting said grading bar vertically with respect to the back side of said frame.
